(19) United States
(12) Patent Application Publication
(10) Pub. No.: US 2026/0050187 A1
(43) Pub. Date: Feb. 19, 2026

(54) DISPLAY DEVICE

(71) Applicants: K-TRONICS (SUZHOU) TECHNOLOGY CO., LTD., Jiangsu (CN); BOE TECHNOLOGY GROUP CO., LTD., Beijing (CN)

(72) Inventors: Lihua SHENG, Beijing (CN); Xingqiang LIU, Beijing (CN); Zhengqi ZHOA, Beijing (CN); Hongfei QIAN, Beijing (CN); Wenbo DONG, Beijing (CN)

(21) Appl. No.: 18/996,044

(22) PCT Filed: Jul. 31, 2023
(86) PCT No.: PCT/CN2023/110092

§ 371 Date: Jan. 17, 2025

(30) Foreign Application Priority Data
Aug. 31, 2022 (CN) 202211055113.2

(51) Int. Cl. G02F 1/1333; G02F 1/1335; G02F 1/1339

(52) U.S. Cl. CPC G02F 1/133388; G02F 1/133314; G02F 1/133325; G02F 1/133504; G02F 1/1339

(57) ABSTRACT

The disclosure provides a display device, the display device includes: a display panel including a display area and a non-display area around the display area; and a first supporting frame arranged at a light incident side of the display panel. The first supporting frame is used for supporting a loaded part, and the loaded part comprises the display panel, and the first supporting frame comprises a supporting portion, and the supporting portion comprises a first supporting surface facing the display panel and parallel to the display panel, the first supporting surface and the loaded part are bonded and fixed by a fixing adhesive, and an orthographic projection of the first supporting surface on the display panel overlaps with the non-display area

### TECHNICAL FIELD

The present disclosure relates to the field of the display technology, in particular to a display device.

### BACKGROUND

Due to its cool appearance and extreme viewing experience, narrow frame display devices are favored by consumers. A conventional narrow frame display device, such as a TV, generally uses a rubber frame to fix a display panel and a back plate, and the frames on three sides are usually 6 mm-10 mm. When watching TV, users feel that there are black strips on three sides, so the conventional narrow frame TV is difficult to be called a real full-screen TV.

With the continuous progress of the preparation technology of the display panel, the width of the non-display area of the display panel is getting narrower and narrower, for example, the width of the non-display area is only 0.9 mm. However, if the conventional rubber frame is used to fix such a display panel, it will still lead to a wider frame, so it is necessary to design a new structure to achieve the effect of extremely narrow frame.

### SUMMARY

According to an aspect of the present disclosure, a display device is provided. The display device comprises: a display panel comprising a display area and a non-display area around the display area; and a first supporting frame arranged at a light incident side of the display panel, wherein the first supporting frame is used for supporting a loaded part, and the loaded part comprises the display panel, and the first supporting frame comprises a supporting portion, and the supporting portion comprises a first supporting surface facing the display panel and parallel to the display panel, the first supporting surface and the loaded part are bonded and fixed by a fixing adhesive, and an orthographic projection of the first supporting surface on the display panel overlaps with the non-display area.

In some embodiments, the display device further comprises a back plate, the back plate and the first supporting frame form a cavity for accommodating the backlight assembly; wherein the first supporting frame further comprises a fixing portion, the fixing portion is at a side of the supporting portion facing away from the display panel, and the fixing portion is fixed with the back plate.

In some embodiments, the fixing portion comprises: a bottom surface facing away from the display panel and parallel to the display panel; a second side surface perpendicular to the bottom surface and facing an outside of the display device; and an inclined surface forming an acute angle with the bottom surface and facing an inside of the display device, wherein the back plate comprises a main body portion parallel to the display panel and a bending portion perpendicular to the main body portion and extending in a direction towards the display panel, the main body portion of the back plate is connected with the bottom surface of the fixing portion, and the bending portion of the back plate is connected with the second side surface of the fixing portion.

In some embodiments, an orthographic projection of the bending portion of the back plate on the display panel is within an orthographic projection of the first supporting frame on the display panel.

In some embodiments, the supporting portion further comprises a first side surface perpendicular to the first supporting surface and facing an inside of the display device, and the first side surface is aligned with an edge of the non-display area adjacent to the display area.

In some embodiments, the loaded part further comprises a glass diffuser between the first supporting surface of the first supporting frame and the display panel, the glass diffuser and the first supporting surface are bonded and fixed by a fixing adhesive, and the glass diffuser is fixed with the display panel.

In some embodiments, a thickness of the glass diffuser is greater than 0.9 mm.

In some embodiments, the loaded part further comprises a quantum dot film between the glass diffuser and the display panel, wherein the glass diffuser and the quantum dot film are fixed by an optical transparent adhesive, and the quantum dot film and the display panel are fixed by an optical transparent adhesive.

In some embodiments, the display device further comprises an edge sealant covering side surfaces of the display panel, the quantum dot film and the glass diffuser facing an outside of the display device.

In some embodiments, the display device further comprises an optical film at a side of the glass diffuser facing away from the display panel, and the optical film and the glass diffuser are fixed by an optical transparent adhesive.

In some embodiments, the display panel and the first supporting surface of the first supporting frame are directly bonded and fixed by a fixing adhesive.

In some embodiments, the first supporting frame further comprises a connecting portion between the supporting portion and the fixing portion.

In some embodiments, the connecting portion of the first supporting frame comprises a second supporting surface facing the display panel and parallel to the display panel, and the display device further comprises a glass diffuser, a quantum dot film and an optical film which are sequentially stacked on the second supporting surface, and the second supporting surface and the glass diffuser are fixed by an optical transparent adhesive, the glass diffuser and the quantum dot film are fixed by the optical transparent adhesive, and the quantum dot film and the optical film are fixed by the optical transparent adhesive.

In some embodiments, the first supporting surface is provided with a first adhesive overflow groove.

In some embodiments, the first adhesive overflow grooves are continuously distributed on the first supporting surface.

In some embodiments, the first adhesive overflow groove is continuously distributed on the first supporting surface.

In some embodiments, an orthographic projection of the first adhesive overflow groove on the display panel is within the non-display area.

In some embodiments, the first supporting frame further comprises a third side surface perpendicular to the first supporting surface and facing a side surface of the loaded part

In some embodiments, the third side surface and the side surface of the loaded part are bonded and fixed by a fixing adhesive.

In some embodiments, the first supporting frame further comprises a second adhesive overflow groove between the first supporting surface and the third side surface.

In some embodiments, a ratio of a width of the non-display area of the display panel to a width of the first supporting surface of the first supporting frame ranges from 0.6 to 0.8.

In some embodiments, the first supporting frame is made of aluminum material.

In some embodiments, the fixing adhesive provides an adhesive strength between the aluminum material and a glass material of more than 4 MPa.

In some embodiments, the display panel is quadrangular, and the first supporting frame is arranged around a first side, a second side and a third side of the display panel.

In some embodiments, a flip-chip film is arranged on a fourth side of the display panel, and the display device further comprises a decorative strip arranged on the fourth side of the display panel and at a light exiting side of the display panel, and the decorative strip at least partially shields the flip-chip film.

In some embodiments, the display device further comprises a decorative frame arranged on the fourth side of the display panel, wherein the decorative strip covers the fourth side of the display panel and an edge of the decorative frame close to the display panel.

In some embodiments, the decorative strip is an aluminum strip electroplated with stainless steel.

In some embodiments, the display device further comprises a rubber frame and a second supporting frame arranged on the fourth side of the display panel, wherein the rubber frame is at least partially on a side of the second supporting frame facing away from an inside of the display device.

In some embodiments, the display device further comprises a decorative frame arranged on the fourth side of the display panel, wherein the decorative frame, the rubber frame and the second supporting frame are fixed by screws, and a part of the rubber frame is between the decorative frame and the second supporting frame.

In some embodiments, the second supporting frame is made of aluminum material, and the second supporting frame is connected with the first side and the third side of the display panel, and the first side and the second side are two sides directly adjacent to the fourth side.

### BRIEF DESCRIPTION OF THE DRAWINGS

In order to more clearly illustrate the technical solutions in embodiments of the disclosure, the drawings needed to be used in the description of the embodiments will be introduced briefly in the following. Obviously, the drawings in the following description are only some embodiments of the disclosure, and for those of ordinary skills in the art, other drawings may be obtained according to these drawings under the premise of not paying out creative work.

FIG. 1 schematically shows a front view of a display device according to an embodiment of the present disclosure;

FIG. 2 schematically shows a cross-sectional view of a display device according to an embodiment of the present disclosure;

FIG. 3 schematically shows a top view of a first adhesive overflow groove according to an embodiment of the present disclosure;

FIG. 4 schematically shows a cross-sectional view of a display device according to another embodiment of the present disclosure;

FIG. 5 schematically shows a cross-sectional view of a display device according to yet another embodiment of the present disclosure;

FIG. 6 schematically shows a cross-sectional view of a display device according to yet another embodiment of the present disclosure; and

FIG. 7 schematically shows a cross-sectional view of a display device according to yet another embodiment of the present disclosure.

The shapes and sizes of the parts in the drawings do not reflect the true proportions of the parts, but only schematically illustrate the disclosure.

### DETAILED DESCRIPTION OF THE DISCLOSURE

In the following, the technical solutions in the embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

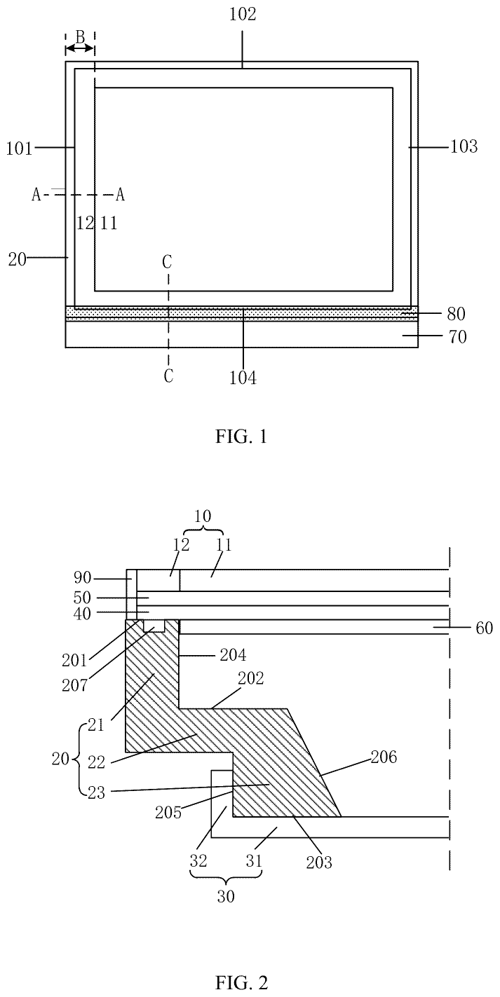

An embodiment of the present disclosure provides a display device. FIG. 1 schematically shows a front view of a display device according to an embodiment of the present disclosure. FIG. 2 schematically shows a cross-sectional view of a display device according to an embodiment of the present disclosure. The cross-sectional view in FIG. 2 is taken along line AA in FIG. 1, for example. Referring to FIG. 1 and FIG. 2, the display device provided by the present disclosure includes a display panel 10, a first supporting frame 20, and a back plate 30. The display panel 10 includes a display area 11 and a non-display area 12 around the display area. The first supporting frame 20 is at the light incident side of the display panel. On the one hand, the first supporting frame can support a loaded part fixed to it, such as a display panel; On the other hand, the first supporting frame can be connected with the back plate to form a cavity for accommodating backlight assembly and the like.

In order to play a supporting role and form a cavity for accommodating backlight assembly, the first supporting frame needs to have certain mechanical strength, and metal materials may be considered to make the first supporting frame. In some embodiments, the first supporting frame may be made of aluminum material. Aluminum material has the advantages of light weight, high strength, high machining accuracy, small tolerance, high surface flatness and low die cost. Therefore, compared with other metal materials, the first supporting frame made of aluminum material can reduce the weight of the display device and save the cost.

In some embodiments, as shown in FIG. 2, the first supporting frame includes a supporting portion 21, which includes a first supporting surface 201 facing the display panel 10 and parallel to the display panel 10, and a loaded part (in FIG. 2, the loaded part is the glass diffuser 40, the quantum dot film 50 and the display panel 510 stacked on the first 20 supporting surface in sequence) is bonded and fixed with the first supporting surface 201 by a fixing adhesive, and an orthographic projection of the first supporting surface 201 on the display panel 10 overlaps with the non-display area 12. When the fixing adhesive is applied, automatic adhesive dispensing may be used to release manpower and avoid poor operation, thus saving manpower cost and improving product yield.

In some embodiments, as shown in FIG. 2, the supporting portion 21 includes a first side surface 204 perpendicular to the first supporting surface 201 and facing the inside of the display device, and the first side surface 204 is aligned with the edge of the non-display area 12 adjacent to the display area 11. In this way, the contact area between the first supporting surface and the loaded part is maximized, and the fixing strength between the first supporting frame and the loaded part is enhanced without affecting the display function of the display area.

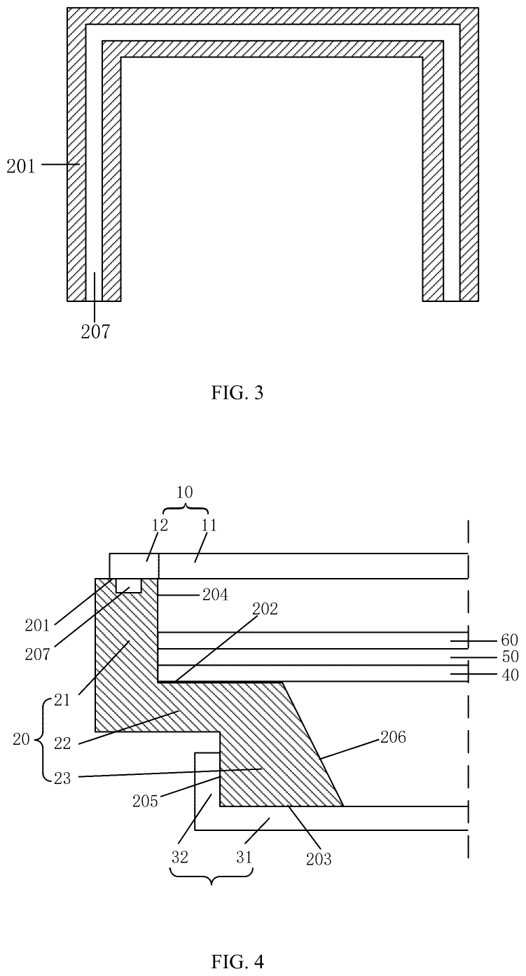

In some embodiments, as shown in FIG. 2, the first supporting surface 201 is provided with a first adhesive overflow groove 207. The first adhesive overflow groove may include a plurality of grooves arranged at intervals, or may be a single groove continuously distributed. FIG. 3 schematically shows a top view of a first adhesive overflow groove according to an embodiment of the present disclosure, in which first adhesive overflow grooves 207 continuously distributed on the first supporting surface 201 are schematically shown. An orthographic projection of the first adhesive overflow groove on the display panel is in the non-display area. As shown in FIG. 3, the first adhesive overflow groove 207 may be arranged in the middle of the first supporting surface 201, or in the portion of the first supporting surface closer to the inside of the display device, or in the portion of the first supporting surface closer to the outside of the display device, as long as the orthographic projection of the first adhesive overflow groove on the display panel is ensured to be in the non-display area. By arranging the adhesive overflow groove on the first supporting surface, when the first supporting frame and the loaded part are fixed by adhesive dispensing, the overflowed adhesive will enter the adhesive overflow groove, which greatly reduces the risk of overflowing into the display area or polluting the backlight assembly.

In some embodiments, the first supporting frame further includes a fixing portion, as shown in FIG. 2, the fixing portion 30 includes: a bottom surface 203 facing away from the display panel 10 and parallel to the display panel 10; a second side surface 205 perpendicular to the bottom surface 203 and facing the outside of the display device; and an inclined surface 206 that forms an acute angle with the bottom surface and faces the inside of the display device. The back plate 30 of the display device may include a main body portion 31 and a bending portion 32, the main body portion 31 is parallel to the display panel 10, and the bending portion 32 is perpendicular to the main body portion 31 and extends in the direction towards the display panel 10. The main body portion 31 is fixed to the bottom surface 203 and the bending portion 32 is fixed to the second side surface 205. By arranging the inclined surface 206 at the fixing portion of the first supporting frame, the area of the bottom surface 203 is correspondingly increased, that is, the contact area between the first supporting frame and the back plate is increased, so that the connection strength between the first supporting frame and the back plate can be strengthened. At the same time, due to the inclined surface 206, a thickness of the fixing portion of the first supporting frame in the direction perpendicular to the second side surface 205 is correspondingly increased. When fixing the bending portion of the back plate and the fixing portion of the first supporting frame with fixing pieces (such as screws), the increased thickness can provide a deeper drilling depth, thereby further strengthening the connection strength between the first supporting frame and the back plate and increasing the stability of the display device.

It should be noted that the fixing method between the fixing portion of the first supporting frame and the back plate is not specifically limited in this disclosure, and the skilled person can choose an appropriate fixing method according to the actual situation.

In some embodiments, as shown in FIG. 2, an orthographic projection of the bending portion 32 of the back plate 30 on the display panel 10 is within an orthographic projection of the first supporting frame 20 on the display panel 10. That is, the back plate will not extend out of the first supporting frame, without resulting in an extra frame of the display device. In some embodiments, as shown in FIG. 2, the first supporting frame 20 further includes a connecting part 22 between the supporting portion 10 and the fixing portion 30, and the connecting part 22 includes a second supporting surface 202 facing the display panel 10 and parallel to the display panel 10. The second supporting surface may be used to support and fix some backlight assembly.

In some embodiments, as shown in FIG. 2 and FIG. 4, a width of the first supporting surface 201 of the first supporting frame 20 is greater than a width of the non-display area 12 of the display panel 10. In this case, when the edge of the first supporting surface near the inside of the display device is aligned with the edge of the non-display area near the display area, the edge of the first supporting surface away from the inside of the display device will protrude from the display panel, and the part of the first supporting frame protruding from the display panel will protect the display panel which is usually fragile during the transportation and installation of the display device.

In some embodiments, a ratio of the width of the non-display area of the display panel to the width of the first supporting surface of the first supporting frame may range from 0.6 to 0.8, for example, the ratio may be 0.65, 0.7, 0.75, etc. When the ratio of the width of the non-display area of the display panel to the width of the first supporting surface of the first supporting frame is too small, the width of the first supporting frame protruding from the non-display area is too large, which will lead to an enlarged frame. When the ratio of the width of the non-display area of the display panel to the width of the first supporting surface of the first supporting frame is too large, the width of the first supporting frame protruding from the non-display area is too small to effectively protect the display panel. For a liquid crystal display panel with a non-display area width of 0.9 mm, the ratio of the width of the non-display area of the display panel to the width of the first supporting surface of the first supporting frame may be selected as, for example, 0.75, that is, the width of the first supporting surface of the first supporting frame is 1.2 mm, and the width of the first supporting frame protruding from the non-display area is 0.3 mm. As shown in FIG. 1, when the edge of the first supporting surface near the inside of the display device is aligned with the edge of the non-display area near the display area, the width of the frame B of the display device is actually the width of the first supporting surface of the first supporting frame. Therefore, for a liquid crystal display panel with a width of 0.9 mm in the non-display area, a display device with a frame of 1.2 mm and a screen ratio of 99% can be obtained. In this case, the appearance of the display device is more cool, and the user is more immersed when watching, which greatly improves the user experience.

In the above-mentioned embodiment, for example, the width of the adhesive overflow groove may be set to 0.5 mm, the depth of the adhesive overflow groove may be set to 0.5 mm, and the adhesive overflow groove is in the middle of the first supporting surface, so that the adhesive overflow groove is in the non-display area of the display panel, which can effectively collect the adhesive that overflows during the adhesive dispensing and fixing process.

FIG. 4 schematically shows a cross-sectional view of a display device according to another embodiment of the present disclosure. In some embodiments, as shown in FIG. 4, the loaded part supported by the first supporting frame 20 may be the display panel 10, that is, the display panel 10 is directly bonded and fixed with the first supporting surface 201 of the first supporting frame 20 by a fixing adhesive. In this case, the glass diffuser 40, the quantum dot film 50 and the optical film 60 may be sequentially stacked on the second supporting surface 202, wherein the glass diffuser 40 and the quantum dot film 50 are fixed by an optical transparent adhesive, and the quantum dot film 50 and the optical film 60 are fixed by an optical transparent adhesive.

In some embodiments, as shown in FIG. 2, the loaded part supported by the first supporting frame 20 may be a glass diffuser 40, a quantum dot film 50 and a display panel 10 which are sequentially stacked on the first supporting surface 201, that is, the first supporting frame 20 and the glass diffuser 40 are fixed by dispensing adhesive. The glass diffuser 40 and the quantum dot film 50 are fixed by optical transparent adhesive, and the quantum dot film 50 and the display panel are fixed by optical transparent adhesive. In this case, the optical film 60 may be arranged on the side of the glass diffuser 40 facing away from the display panel, and the optical film 60 and the glass diffuser 40 may be fixed by optical transparent adhesive. It should be noted that, as shown in FIG. 2, the edges of the glass diffuser 40 and the quantum dot film 50 do not exceed the edge of the display panel 10. Here, the optical film 60 may include, for example, a prism sheet, an incremental film, a condenser sheet, and the like.

The deformation space provided by the first supporting frame made of aluminum material is very limited when the temperature changes, and the deformation of the glass diffuser adopted in the embodiment of the present application is very small when it expands when heated and contracts when cooled. Compared with the diffuser made of organic materials, the glass diffuser can ensure the stability of the display device when it undergoes temperature changes. At the same time, in order to achieve the effect of extremely narrow frame, the area between the first supporting frame and the loaded part can be fixed with adhesive is very limited, and the display panel itself is usually fragile. If the display panel is only fixed on the first supporting surface, it is easy to damage the display panel. Therefore, the glass diffuser is selected to support the display panel in a composite way, which is convenient for the bonding operation. In order to provide sufficient support strength and bonding strength, the thickness of the glass diffuser may be designed to be greater than 0.9 mm, for example, 1.1 mm.

In some embodiments, as shown in FIG. 2, the display device further includes an edge sealant 90 covering the side surfaces of the display panel 10, the quantum dot film 50 and the glass diffuser 40 facing the outside of the display device. The edge sealant may be black, which plays a mechanical protection role on the display panel, the quantum dot film and the glass diffuser, and on the other hand, prevents external light from entering the display device from the side surfaces, thus ensuring a good display effect.

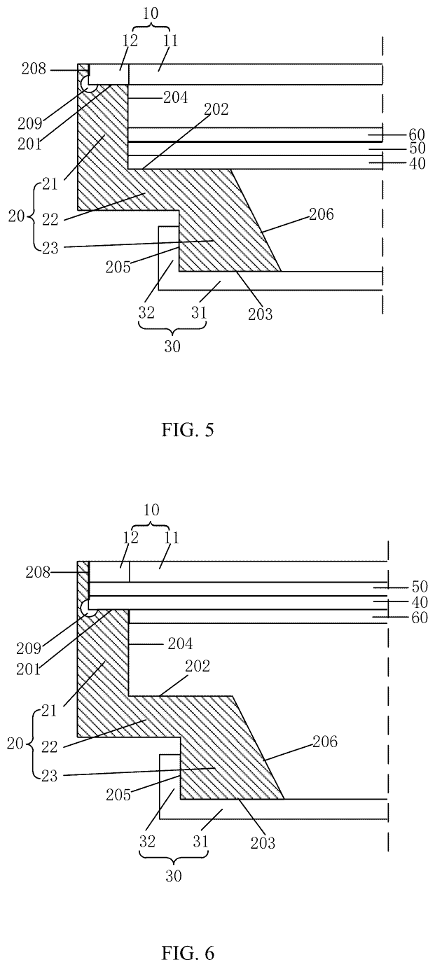

FIG. 5 and FIG. 6 schematically show cross-sectional views of display devices according to other embodiments of the present disclosure. As shown in FIG. 5 and FIG. 6, the first supporting frame 20 further includes a third side surface 208 perpendicular to the first supporting surface 201 and facing the side surface of the loaded part, and the third side surface 208 and the side surface of the loaded part are bonded and fixed by the fixing adhesive. In this case, the first supporting frame is not only fixed to the loaded part through the first supporting surface, but also fixed to the loaded part through the third side surface, thereby increasing the area where adhesive can be applied and enhancing the fixing strength between the first supporting frame and the loaded part. At the same time, since the third side surface of the first supporting frame surrounds the side surface of the loaded part (which includes the display panel), it can protect the display panel more effectively.

In the embodiments shown in FIG. 5 and FIG. 6, since both the first supporting surface 201 and the third side surface 208 are coated with adhesive, a second adhesive overflow groove 209 between the first supporting surface 201 and the third side surface 208 may be provided. When the first supporting frame and the loaded part are fixed by dispensing adhesive, the second adhesive overflow groove 209 between the first supporting surface 201 and the third side surface 208 can collect the adhesive overflowing from the first supporting surface 201 and the third side surface 208 at the same time, thus greatly reducing the risk of overflowing into the display area or polluting the backlight assembly.

It should be noted that, in the case of disposing the second overflow groove, the first overflow groove may or may not be disposed. With regard to the specific shapes of the first overflow groove and the second overflow groove, the first overflow groove is shown as a square in FIG. 2 and FIG. 4, and the second overflow groove is shown as an arc in FIG. 5 and FIG. 6. However, this is not intended to limit the specific shapes of the overflow grooves, and those skilled in the art can reasonably design the shapes of the overflow grooves according to the actual amount of adhesive applied and the processing accuracy.

In some embodiments, as shown in FIG. 4, the loaded part supported by the first supporting frame 20 may be the display panel 10, that is, the display panel 10 is directly bonded and fixed with the first supporting surface 201 of the first supporting frame 20 by a fixing adhesive. In this case, the glass diffuser 40, the quantum dot film 50 and the optical film 60 may be sequentially stacked on the second supporting surface 202, wherein the glass diffuser 40 and the quantum dot film 50 are fixed by an optical transparent adhesive, and the quantum dot film 50 and the optical film 60 are fixed by an optical transparent adhesive.

In some embodiments, as shown in FIG. 5, the loaded part supported by the first supporting frame 20 may be the display panel 10, that is, the display panel 10 is directly fixed with the first supporting surface 201 and the third side surface 208 of the first supporting frame 20 by dispensing adhesive. In this case, the glass diffuser 40, the quantum dot film 50 and the optical film 60 may be sequentially stacked on the second supporting surface 202, wherein the glass diffuser 40 and the quantum dot film 50 are fixed by an optical transparent adhesive, and the quantum dot film 50 and the optical film 60 are fixed by an optical transparent adhesive.

In some embodiments, as shown in FIG. 6, the loaded part supported by the first supporting frame 20 may be a glass diffuser 40, a quantum dot film 50 and a display panel 10 which are sequentially stacked on the first supporting surface 201, that is, the first supporting frame 20 is fixed with the bottom surface of the glass diffuser 40 facing away from the display panel and the side surfaces of the glass diffuser 40, the quantum dot film 50 and the display panel 10 by dispensing adhesive. The glass diffuser 40 and the quantum dot film 50 are fixed by an optical transparent adhesive, and the quantum dot film 50 and the display panel are fixed by an optical transparent adhesive. In this case, the optical film 60 may be arranged on the side of the glass diffuser 40 facing away from the display panel, and the optical film 60 and the glass diffuser 40 may be fixed by an optical transparent adhesive. Here, the optical film 60 may include, for example, a prism sheet, an incremental film, a condenser sheet, and the like.

The deformation space provided by the first supporting frame made of aluminum material is very limited when the temperature changes, and the deformation of the glass diffuser adopted in the embodiments of the application is very small when it expands when heated and contracts when cooled. Compared with the diffuser made of organic materials, the glass diffuser can ensure the stability of the display device when it undergoes temperature changes. At the same time, in order to achieve the effect of extremely narrow frame, the area between the first supporting frame and the loaded part can be fixed with adhesive is very limited, and the display panel itself is usually fragile. If the display panel is only fixed on the first supporting surface, it is easy to damage the display panel. Therefore, the glass diffuser is selected to support the display panel in a composite way, which is convenient for the bonding operation. In order to provide sufficient support strength and bonding strength, the thickness of the glass diffuser may be designed to be greater than 0.9 mm, for example, 1.1 mm.

In the disclosure, when two optical elements are fixed with the optical transparent adhesive, the optical transparent adhesive may be coated on the edges of the opposite surfaces of the two elements, which can minimize the influence of the optical transparent adhesive on the optical properties of the two optical elements to be fixed and simplify the process.

It should be noted that the embodiments of the application only show the quantum dot film between the display panel and the glass diffuser. In fact, other optical films may be included between the display panel and the quantum dot film, or between the quantum dot film and the glass diffuser, which is not specifically limited herein. For example, a cast polypropylene (CPP) film may be provided between the display panel and the quantum dot film. The display panel usually generates a lot of heat when operating, the quantum dot film is sensitive to temperature, and its light conversion performance will be affected by high temperature. Therefore, disposing a high-temperature resistant CPP protective film between the display panel and the quantum dot film can effectively block the heat generated by the display panel and ensure the normal function of the quantum dot film.

TABLE 1

| | | Specification | |
|---|---|---|---|
| Item | Test method/condition | parameter | |
| appearance | eye-measurement | black | |
| viscosity (mPa · s) | Broolfield RVT. spindle #27 | 4000-6000/80° C. | |
| density (g/cm³) | | 1.15 ± 0.05 | |
| smell | / | none | |
| curing rate (%) | / | 4 | |
| curing time (h) | / | 24 | h |
| elongation at break | / | 300% | |
| curing energy | / | 5000 | mJ/cm² |
| curing depth | / | 1 | mm |
| bonding strength | glass-PC (tensile shear) | >4 | |
| (MPa) | PC/PET-Al(tensile shear) | >2 | |
| | glass-Al (tensile shear) | >4 | |
| high-temperature aging | | pass | |
| high temperature and | | pass | |
| humidity | | | |

| | |
|---|---|
| cold and hot shock | pass |

FIG. 2 and FIGS. 4-6 schematically show some embodiments, and those skilled in the art can reasonably adjust the relative positions of the display panel and the backlight assembly without affecting the display effect. In order to achieve the effect of extremely narrow frame, the area between the first supporting frame and the loaded part can be fixed by adhesive is very limited, so the adhesive is needed to provide enough bonding strength to ensure the mass production of the display device proposed in the application. The fixing adhesive used in the embodiments of the application needs to provide bonding strength greater than 4 MPa between aluminum material and glass material. Table 1 shows some basic parameters of the fixing adhesive used in the application.

In some embodiments, as shown in FIG. 1, the display panel is quadrangular, and the first supporting frame 20 is arranged around the first side 101, the second side 102 and the third side 103 of the display panel. The display device can present the effect of extremely narrow borders on these three sides. The fourth side 104 of the display panel is usually provided with a flip-chip film. The display device may be provided with a decorative frame 70 near the fourth side of the display panel.

In some embodiments, as shown in FIG. 1, the display device may further include a decorative strip 80 arranged on the fourth side of the display panel and located on the light exiting side of the display panel. The decorative strip 80 covers the fourth side of the display panel and the edge of the decorative frame 70 close to the display panel. The decorative strip can blur the boundary between the display panel and the decorative frame. For example, the decorative strip may be an aluminum strip electroplated with stainless steel. Because the color of electroplated stainless steel is very close to the color of the display panel, it can approximate the effect of extremely narrow borders on four sides.

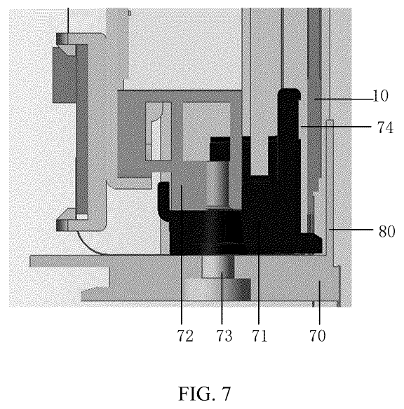

FIG. 7 schematically shows a cross-sectional view of a display device according to yet another embodiment of the present disclosure. FIG. 7 may be taken along the CC line in FIG. 1, for example. In some embodiments, as shown in FIG. 7, the fourth side of the display panel is further provided with a rubber frame 71 and a second supporting frame 72. The decorative frame 70, the rubber frame 71 and the second supporting frame 72 are fixed by screws 73, and a part of the rubber frame 72 is between the decorative frame 70 and the second supporting frame 72. In some embodiments, the second supporting frame may be made of aluminum material, and the second supporting frame 72 may be connected with the parts of the first supporting frame located at the first side 101 and the third side 103 of the display panel. As shown in FIG. 1, the first side 101 and the third side 103 of the display panel are two sides directly adjacent to the fourth side 104. In the embodiment shown in FIG. 7, the surface of the rubber frame 71 facing the display panel 10 includes a groove 74, and a silicone rubber strip may be arranged in the groove 74, which can play a buffering role between the display panel and the rubber frame. It should be noted that the above embodiment only schematically shows a part of backlight assembly, such as glass diffuser, quantum dot film, optical films, etc. As known to those skilled in the art, the display device also includes components such as light source, reflector, prism sheet, polarizer, etc. For backlight assembly not shown in the disclosure, and other conventional components of the display device, those skilled in the art can reasonably arrange them according to the actual situation.

The display device described in the disclosure may be any product or component with display function, such as a mobile phone, a tablet computer, a television, a display, a notebook computer, a digital photo frame, a navigator, etc.

In the disclosure, when describing that two surfaces are “vertical”, it means that the included angle between the two surfaces is about 90 degrees, for example, 85-95 degrees. The “vertical” here is not intended to emphasize the vertical in the geometric sense, but may include machining errors and chamfering that may exist in the actual manufacturing process of components. Similarly, when two surfaces or elements are described as “parallel”, it can also include errors that may exist in the actual processing of the elements, or the inclination of a very small angle (for example, less than 2 degrees) due to the adhesive coated between the two elements for fixing.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present disclosure.

Spatial relative terms such as “row”, “column”, “under”, “above”, “left”, “right” and the like may be used to describe the relationship between one element or feature and another element or feature as shown in the figures for convenience of description. It will be understood that these spatially relative terms are intended to cover different orientations of devices in use or operation other than those depicted in the figures. For example, if the device in the figures is turned over, elements described as “under other elements or features” will be oriented as “above other elements or features”. Thus, the exemplary term “under” can cover both orientations above and below. Devices can be oriented in other ways (rotated by 90 degrees or in other orientations) and the spatial relative descriptors used herein should be interpreted accordingly. In addition, it will also be understood that when a layer is referred to as “between two layers”, it may be the only layer between the two layers, or there may be one or more intermediate layers.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In the description of the present specification, the description referring to the terms “an embodiment”, “some embodiments”, “an example”, “a specific example”, or “some examples” or the like means a specific feature, structures, materials, or characteristics described in conjunction with the embodiment or example are included in at least one embodiment or example of the present disclosure. In this specification, the schematic expression of the above terms does not necessarily have to refer to the same embodiment or example. Furthermore, the specific features, structures, materials, or characteristics described can be combined in any suitable manner in any one or more of the embodiments or examples. In addition, those skilled in the art can combine the different embodiments or examples described in this specification and features of different embodiments or examples without conflicting with each other.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present. In no event, however, should “on” or “directly on” be construed as requiring a layer to completely cover an underlying layer.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A display device comprising:
a display panel comprising a display area and a non-display area around the display area; and
a first supporting frame arranged at a light incident side of the display panel,
wherein the first supporting frame is used for supporting a loaded part, and the loaded part comprises the display panel, and
the first supporting frame comprises a supporting portion, and the supporting portion comprises a first supporting surface facing the display panel and parallel to the display panel, the first supporting surface and the loaded part are bonded and fixed by a fixing adhesive, and an orthographic projection of the first supporting surface on the display panel overlaps with the non-display area.

2. The display device according to claim 1, further comprising a back plate, wherein the back plate and the first supporting frame form a cavity for accommodating the backlight assembly;
wherein the first supporting frame further comprises a fixing portion, the fixing portion is at a side of the supporting portion facing away from the display panel, and the fixing portion is fixed with the back plate.

3. The display device according to claim 2, wherein the fixing portion comprises: a bottom surface facing away from the display panel and parallel to the display panel; a second side surface perpendicular to the bottom surface and facing an outside of the display device; and an inclined surface forming an acute angle with the bottom surface and facing an inside of the display device,
wherein the back plate comprises a main body portion parallel to the display panel and a bending portion perpendicular to the main body portion and extending in a direction towards the display panel,
the main body portion of the back plate is connected with the bottom surface of the fixing portion, and the bending portion of the back plate is connected with the second side surface of the fixing portion.

4. The display device according to claim 3, wherein an orthographic projection of the bending portion of the back plate on the display panel is within an orthographic projection of the first supporting frame on the display panel.

5. The display device according to claim 1, wherein the supporting portion further comprises a first side surface perpendicular to the first supporting surface and facing an inside of the display device, and the first side surface is aligned with an edge of the non-display area adjacent to the display area.

6. The display device according to claim 1, wherein the loaded part further comprises a glass diffuser between the first supporting surface of the first supporting frame and the display panel, the glass diffuser and the first supporting surface are bonded and fixed by a fixing adhesive, and the glass diffuser is fixed with the display panel, and
wherein a thickness of the glass diffuser is greater than 0.9 mm.

7. (canceled)

8. The display device according to claim 6, wherein the loaded part further comprises a quantum dot film between the glass diffuser and the display panel, wherein the glass diffuser and the quantum dot film are fixed by an optical transparent adhesive, and the quantum dot film and the display panel are fixed by an optical transparent adhesive, and
wherein the display device further comprises an edge sealant covering side surfaces of the display panel, the quantum dot film and the glass diffuser facing an outside of the display device.

9. (canceled)

10. The display device according to claim 6, further comprising an optical film at a side of the glass diffuser facing away from the display panel, and the optical film and the glass diffuser are fixed by an optical transparent adhesive.

11. The display device according to claim 1, wherein the display panel and the first supporting surface of the first supporting frame are directly bonded and fixed by a fixing adhesive, and
wherein the first supporting frame further comprises a connecting portion between the supporting portion and the fixing portion.

12. (canceled)

13. The display device according to claim 12, wherein the connecting portion of the first supporting frame comprises a second supporting surface facing the display panel and parallel to the display panel, and the display device further comprises a glass diffuser, a quantum dot film and an optical film which are sequentially stacked on the second supporting surface, and the second supporting surface and the glass diffuser are fixed by an optical transparent adhesive, the glass diffuser and the quantum dot film are fixed by the optical transparent adhesive, and the quantum dot film and the optical film are fixed by the optical transparent adhesive.

14. The display device according to claim 1, wherein the first supporting surface is provided with a first adhesive overflow groove, and
wherein the first adhesive overflow groove is continuously distributed on the first supporting surface.

15. (canceled)

16. The display device according to claim 14, wherein an orthographic projection of the first adhesive overflow groove on the display panel is within the non-display area.

17. The display device according to claim 1, wherein the first supporting frame further comprises a third side surface perpendicular to the first supporting surface and facing a side surface of the loaded part.

18. The display device according to claim 17, wherein the third side surface and the side surface of the loaded part are bonded and fixed by a fixing adhesive.

19. The display device according to claim 17, wherein the first supporting frame further comprises a second adhesive overflow groove between the first supporting surface and the third side surface.

20. The display device according to claim 1, wherein a ratio of a width of the non-display area of the display panel to a width of the first supporting surface of the first supporting frame ranges from 0.6 to 0.8.

21. The display device according to claim 1, wherein the first supporting frame is made of aluminum material.

22. The display device according to claim 21, wherein the fixing adhesive provides an adhesive strength between the aluminum material and a glass material of more than 4 MPa.

23. The display device according to claim 1, wherein the display panel is quadrangular, and the first supporting frame is arranged around a first side, a second side and a third side of the display panel.

24. The display device according to claim 23, wherein a flip-chip film is arranged on a fourth side of the display panel, and the display device further comprises a decorative strip arranged on the fourth side of the display panel and at a light exiting side of the display panel, and the decorative strip at least partially shields the flip-chip film.

25-29. (canceled)
